(19) United States
(12) Patent Application Publication
(10) Pub. No.: US 2026/0184251 A1
(43) Pub. Date: Jul. 2, 2026

(54) Adjustable Sleeping Surface for Vehicles with Beds

(71) Applicant: David Sousa, San Diego, CA (US)

(72) Inventor: David Sousa, San Diego, CA (US)

(21) Appl. No.: 19/005,240

(22) Filed: Dec. 30, 2024

(51) Int. Cl. B60N 3/00

(52) U.S. Cl. CPC B60N 3/008; B60N 3/001

(57) ABSTRACT

A robust, mechanically adjustable, self-leveling sleeping surface for vehicles, that folds out of the way, against the vehicle wall to allow for more living and storage space. The apparatus contains a sleeping surface, attached to the inner of two, concentric frames, each hinged on a different axis and each adjusted by two, linear actuators; each supporting the opposite corners of the frame; allowing individual adjustment to the “x” and “y” axis while maintaining the structural integrity of the apparatus. The apparatus can be configured for installation at different heights and can include an optional ladder, table and second sleeping surface to be installed above or below the primary sleeping surface.

### CROSS-REFERENCE TO RELATED APPLICATIONS

This non-provisional patent application claims the benefit of the provisional application No. 63/629,451 which has a filing date of Oct. 27, 2023.

### STATEMENT REGARDING FEDERALLY SPONSORED RESEARCH OR DEVELOPMENT

Not applicable.

### REFERENCE TO SEQUENCE LISTING, LARGE TABLE, OR A COMPUTER PROGRAM

Not applicable.

### BACKGROUND OF THE INVENTION

Touring, camping, and living in vans, recreational vehicles, and trailers has become more and more popular and sometimes necessary for many people across the US. In most cases, parking surfaces are unpredictably uneven, creating a lopsided sleeping surface on any bed mounting inside the vehicle. Additionally, storage and living space is very limited inside a vehicle, and a bed reduces this space even further. This invention is meant to solve the problem of a lopsided sleeping surface due to parking an RV or camping vehicle on an angled or uneven surface while adding the feature of folding up and out of the way when it's not in use, creating more living and storage space.

### PRIOR ART

Some related but vastly different inventions include the following:
Document ID US 20220175147 A1/application Ser. No. 17/117,095 attempts to solve this problem without success and the patent application was abandoned.
Patent #US 20220110449 A1/application Ser. No. 17/604,656 sites a leveling bed but due to using only 3 points of contact from the floor to the bed frame, creates a geometrically unsound and potentially unstable surface when being used as a bed. It also does not fold out of the way and takes up critical living and storage space in the vehicle.
Patent #US 20180125254 A1/application Ser. No. 15/344936 sites an air mattress which uses air bladders to change the angle of the sleeping surface, which only works in one direction and would lend itself to being very inaccurate providing an overall level surface.
Patent #US 20170150824 A1 describes an apparatus which adjusts the height of different portions of a mattress to vary the contours of the surface to alleviate pressure points and pain in the sleeper. This is not a system to level the bed.

This invention solves all these problems by allowing adjustment to the “x” and “y” axis (left to right and front to back) using separate, structural frames supported firmly from four points close to each corner. Each frame (“x” axis frame and “y” axis frame) is adjusted independently, allowing each frame to be rigid and geometrically sound. Additionally, this invention allows the sleeping surface to fold up and out of the way against a wall, allowing for more living and storage space in the vehicle when the bed is not in use.

### BRIEF SUMMARY

A sleeping surface for vehicles which is mechanically operated and adjustable in a way that allows the sleeping surface to be level when the vehicle is parked on a sloped or uneven surface. Furthermore, this sleeping surface for vehicles, folds out of the way, against a wall, allowing for more living and storage space. This adjustable sleeping surface is comprised of a flat sleeping surface to lay a mattress or foam pad on. This surface can be solid or have a flexible fabric stretched across the frame to support the mattress, providing additional, body conforming properties to the mattress. The sleeping surface has an inner metal frame which allows for adjustment along the “x” axis (head to feet) and is attached to an outer metal frame which allows for adjustment along the “y” axis (left side to right side). There are electric, linear actuators that can be activated by a switch to manually adjust the bed. There is a leveling bubble attached on each axis to aid in determining the point you've achieved a level platform. These leveling bubbles can have an electrical sensor that can be engaged to automatically control the linear actuators to adjust the angle and will automatically adjust the bed to a level position. This whole assembly can be bolted to the floor and one wall and can attach to an assembly on the opposite wall with a latch. When this latch is disengaged, the sleeping surface assembly is able to fold up and against the wall it is attached to, opening up the vehicle to provide more living and storage space.

### BRIEF DESCRIPTION OF THE DRAWINGS

FIG. 1 is a perspective view of the invention without accessories

### LIST OF REFERENCE NUMERALS

1—Sleeping surface
2—Inner frame
3—Outer frame
4—Outer frame support bracket and latch system
5—Linear actuator
6—Linear or linear chain actuator
7—Linear actuator mounting bracket to wall or floor
8—Outer frame hinge mounting bracket to wall and floor
9—Mounting holes
10—Inner frame hinge
11—Articulating arm hinge assembly
12—Outer frame hinge bearing
13—Positioning pin for outer frame hinge assembly

### DETAILED DESCRIPTION

The present invention relates to an adjustable sleeping surface for vehicles, which allows the sleeping surface to be level when the vehicle is parked on an un-level surface. Furthermore, the present invention folds out of the way when not in use.

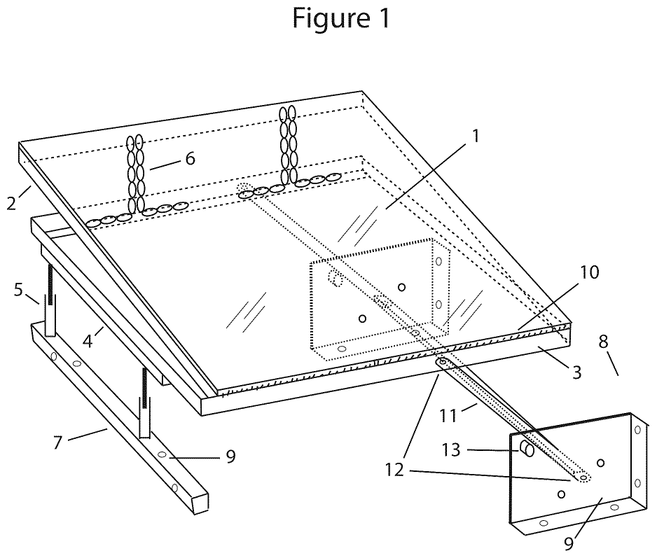

FIG. 1 shows a perspective view of the invention without attached accessories. In the preferred embodiment, the sleeping surface is made from a flexible and resilient, elastic fabric that breathes; allowing air flow to the mattress that would lay on top of it, however, the sleeping surface could be made from a solid sheet of aluminum or a similar, rigid material.

The sleeping surface is attached to an inner frame. In the preferred embodiment, the inner frame is attached to an outer frame using a hinge on one edge and supported on the opposite two corners with manually or electrically operated linear actuators, allowing the horizontal angle of the frame to be adjusted along the “x” axis (from head to toe when lying on the sleeping surface).

The outer frame is attached to a set of mounting brackets which allow the assembly to be attached to the floor and/or walls of a vehicle. This outer frame is attached using a hinge system and with linear actuators on an axis perpendicular to the hinge on the inner frame; allowing adjustment of the angle of the bed on the “y” axis (from left to right when lying on the sleeping surface).

In the preferred embodiment, the outer frame is attached to the brackets using an articulating arm hinge system on one side and a set of linear actuators on the other side. The outer frame is secured to the linear actuators with a latch system that allows the edge of the outer frame to disconnect from the linear actuators and move freely on the articulating arm hinges. When the latch is released, the articulating arm hinges allow the bed surface and frame system to fold up against the wall.

In the preferred embodiment, the upper hinge bearing for the articulating arm hinge assembly has a spring-loaded hinge to force the upper hinge joint to straighten before the lower hinge when folding the bed assembly against the wall.

In the preferred embodiment, the lower bearing in the articulating outer frame hinge assembly is attached to a bracket which bolts to the floor and the wall of the vehicle.

1. An apparatus for supporting and leveling a sleeping surface in a vehicle, comprising:
a solid or flexible and resilient platform to hold a sleeping surface or mattress;
an adjustable framework to support the platform;
a means for adjusting the angle of the framework, both on the x-axis and
y-axis, relative to the floor or mounting surface;
a means for attaching the apparatus to the floor or wall of a vehicle.

2. The apparatus of claim 1, wherein the apparatus includes a means to fold the apparatus up against the wall.

3. The apparatus of claim 2, wherein the means for adjusting the angle of the platform or frame comprises:
two concentric, rectangular frames;
each hinged on one side, perpendicular to the hinge on the other;
each with two linear actuators, supporting the corners opposite the hinge;
the inner frame adjusting the angle along one axis (“x”);
the outer frame adjusting the angle of the sleeping surface along a perpendicular axis (“y”).

4. The apparatus of claim 3, wherein the frame sections include a leveling bubble, providing a reference when adjusting the sleeping surface to a level position.

5. The apparatus of claim 4, wherein the leveling bubble contains an electronic sensor which sends a signal to an electronic control unit that tells the linear actuators when and how far to adjust the platform.

6. The apparatus of claim 4, wherein the apparatus contains an accessory stair or ladder allowing easier access to the sleeping platform when in use.

7. The apparatus of claim 4, wherein the apparatus contains an accessory bench or table for use when the sleeping platform is stowed away against the wall.

8. The apparatus of claim 4, wherein the apparatus contains second sleeping platform above the primary sleeping platform.

9. The apparatus of claim 4, wherein the apparatus contains second sleeping platform below the primary sleeping platform.
